(19) United States
(12) Patent Application Publication
(10) Pub. No.: US 2009/0194576 A1
(43) Pub. Date: Aug. 6, 2009

(54) POWER BEATING DEVICE

(76) Inventor: Feng-Ho WANG, Hsinchu (TW)

Correspondence Address: Feng-Ho WANG, 235 Chung - Ho, Box 8-24, Taipei, 235, TW

(21) Appl. No.: 12/025,725

(22) Filed: Feb. 4, 2008

(51) Int. Cl. B25C 1/00

(52) U.S. Cl. 227/146

(57) ABSTRACT

A power beating device using the inclined plane principle comprises: a driving unit having a spring for storing and releasing energy so as to drive an impact unit; wherein the driving unit has at least one driving surface; an actuator serves to actuate the driving surface so that the impact unit is lifted with the driving unit, and the spring deform to store energy; when the impact unit is lifted to a predetermined height, it will rest and then the spring will release energy to drive the impact unit to have the effect of beating.

### FIELD OF THE INVENTION

The present invention relates to a power beating device, and particularly to a power beating device used in a nail or staple driver, which has a set of driving unit containing a spring as an energy storage and releasing devices for driving an impact unit.

### BACKGROUND OF THE INVENTION

Generally, a power beating device uses a driving unit, such as a liner movement of an electromagnet or a simple harmonic motion from the rotation movement of a motor, to resist against an energy storage unit, for example to use a spring to cause an impact unit to move from a first position to a second position so as to store the potential energy from electric energy. When the spring moves to a second position, the storage energy is converted into the dynamic energy of the impact unit so as to drive a nail into a work piece. The requirement of this kind of power beating device is that it must be light and power saved. However the defects of the electromagnetic driving are heavy and power consumed, while the simple harmonic motion from the rotation movement of a motor is that the power is unstable, especially when the impact unit moves to an impact position driving the nail, the spring needs a great driving force, but at this moment, the simple harmonic motion from the rotation movement of a motor is at a maximum value in the sinusoidal moving curve. To compensate this defect, in U.S. Pat. No. 4,811,885 A1, in the simple harmonic motion from the rotation movement of a motor, a flywheel is added for providing a greater pushing force to the spring as the spring moves to a distal end for driving the impact unit to beat the nail. However the flywheel consumes more power and is uneconomic.

In U.S. Pat. No. 4,953,774, another power beating device is disclosed, in that in the simple harmonic motion from the rotation movement of a motor, the spring has different pitches so as to improve the phase deficiency in the simple harmonic motion from the rotation movement of a motor. Furthermore, a cam unit is provided. The cam unit can reset the impact unit as in the distal end, the driving force is insufficient so that the impact unit is buckled in a dead point, while the power nail driver is power off. However all these devices will make the device complicated and can not improve the prior art defect effective.

### SUMMARY OF THE INVENTION

In the present invention, an inclined plane principle is used for improving power efficiency and reduce the weight is disclosed. A power beating device using an inclined plane comprises: a driving unit has a spring for storing and releasing energy so as to drive an impact unit; wherein the driving unit has at least one driving surface; an actuator serves to actuate the driving surface so that the impact unit is lifted with the driving unit, and the spring deform to store energy; when the impact unit is lifted to a predetermined height, it will rest and then the spring will release energy to drive the impact unit 40 to have the effect of beating. Thus the prior linear driving by using electromagnet or the rotation driving by using motor to convert into simple harmonic reciprocating motion are improved by the present invention so that it can resist against the energy storage unit instead of an operation by an inefficiency energy storage process.

Another object is to use a proper height h and an elastic coefficient k to control an output torque of a motor so that the output torque of the motor is retained with a constant value and meanwhile, the rotation speed, current, and output torque of a motor is controllable. Thus the rated power of the motor is reduced and thus the sizes of the motor and battery are also reduced. Further, the height h and the elastic coefficient k are designed to improve the efficiency of the motor and save power.

To achieve about object, the present invention provides a power beating device which is installed with a driving unit. The driving unit 2 is a round cylinder which is driven by an actuator 30. A driving surface 11 of the driving rotary cylinder 10 is an helical surface. The helical angle θ thereof is varied with a height h. The height is increased in the rotation direction. When the height achieves to a maximum displacement of a spring, then the height is reset. When the driving unit 2 moves, an impact unit 40 is lifted with the driving surface 11 of the driving unit 2. The spring 20 also stores energy. The increment of the driving surface 11 of the driving unit 2 is designed to make the driving resisting force in the energy storage process is wholly controlled manually. That is to say, the user can control the power supply curve of a motor. For example, the height of the driving surface 11 of the driving unit 2 is designed properly so that the time variation of the increment of the height (Δh/Δt) is increased with the resistance force (f) of the displacement (Δs) of the spring 20, and then the output torque of the motor is retained to a constant value. Furthermore, the rotation speed, current, output torque, and efficient of the motor is controllable. Thus the rated power of the motor is reduced and thus the sizes of the motor and battery are also reduced. Further, the height h and the elastic coefficient k are designed to improve the efficiency of the motor and save power.

Moreover, in the present invention, the driving unit 2 is a wedge driving block which is driven by an actuator 30, the driving surface 11 of the driving block has an inclined plane and the driving unit 2 has at least one driving surface 11; there is at least one impact unit 40; a height of the impact unit 40 is increased with the displacement of the impact unit 40; the displacement of the impact unit 40 is a

teethed shape so as to cause the spring 20 has a maximum displacement and then the height is reset.

The various objects and advantages of the present invention will be more readily understood from the following detailed description when read in conjunction with the appended drawing.

### BRIEF DESCRIPTION OF THE DRAWINGS

FIG. 1 is a schematic perspective view of one preferred embodiment of the power beating device of the present invention.

FIG. 2 an explosive schematic view about the preferred embodiment of the power beating device of the present invention.

FIG. 3 is a lateral view of a preferred embodiment of the power beating device of the present invention.

FIG. 4 is a cross sectional view about the preferred embodiment of the power beating device of the present invention.

FIG. 5 is a schematic view showing the operation of the present invention.

FIG. 6 is another schematic view showing the operation of the present invention.

FIG. 7 is a further schematic view about the operation of the present invention.

FIG. 8 is a schematic view showing another driving rotary cylinder according to the power beating device of the present invention.

FIG. 9 is a cross sectional view about the power beating device of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

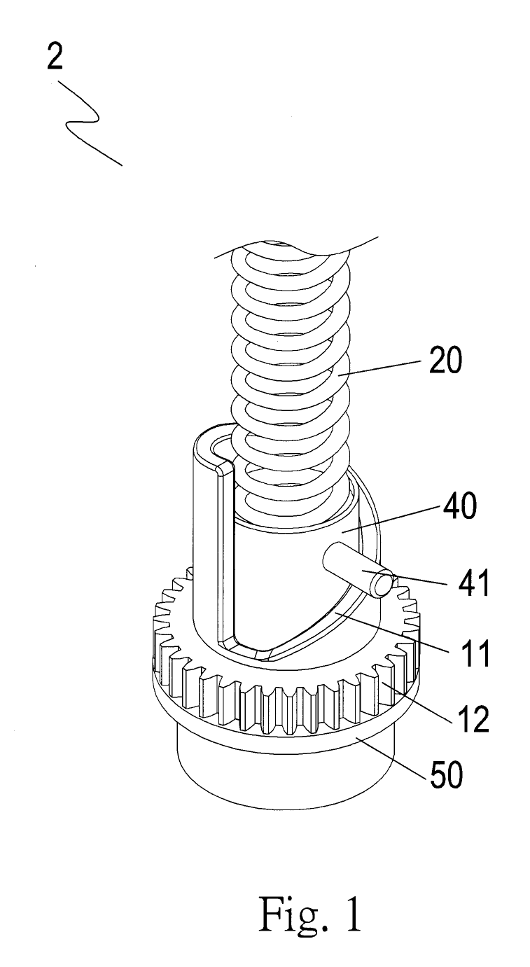

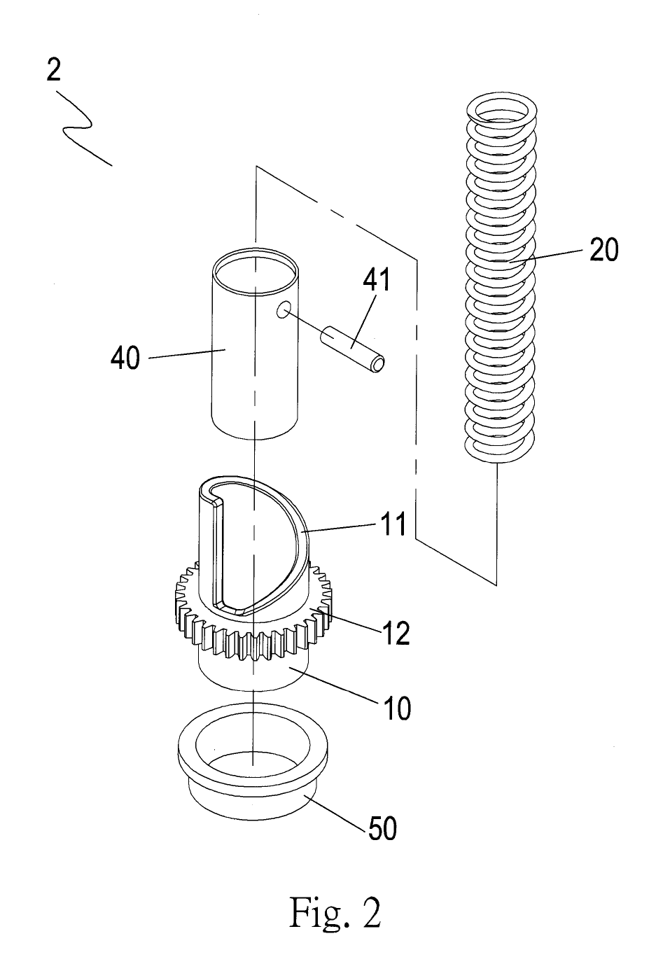

With referring to FIGS. 1 and 2, the power beating device of the present invention includes the following elements.

A set of driving unit 2 has a spring 20 for storing and releasing energy, an impact unit 40, a driving rotary cylinder 10 and a driving bush 50. The spring 20 drives an impact unit 40. The driving pin 41 inserts into the impact unit 40. The driving rotary cylinder 10 has a driven gear 12 at an outer periphery thereof and a wedge helical driving surface 11 above the driven gear 12. The driving bush 50 is installed at a lower side of the driving rotary cylinder 10. The driven gear 12 is driven to rotate in the driving bush 50. In assembly, the spring 20 is received in the impact unit 40 and then the impact unit 40 is received in the wedge helical driving surface 11.

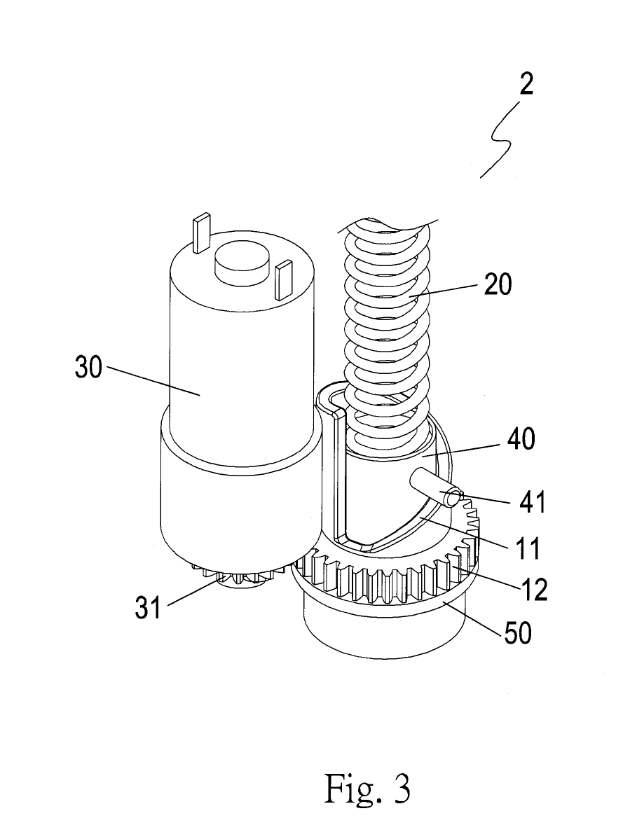

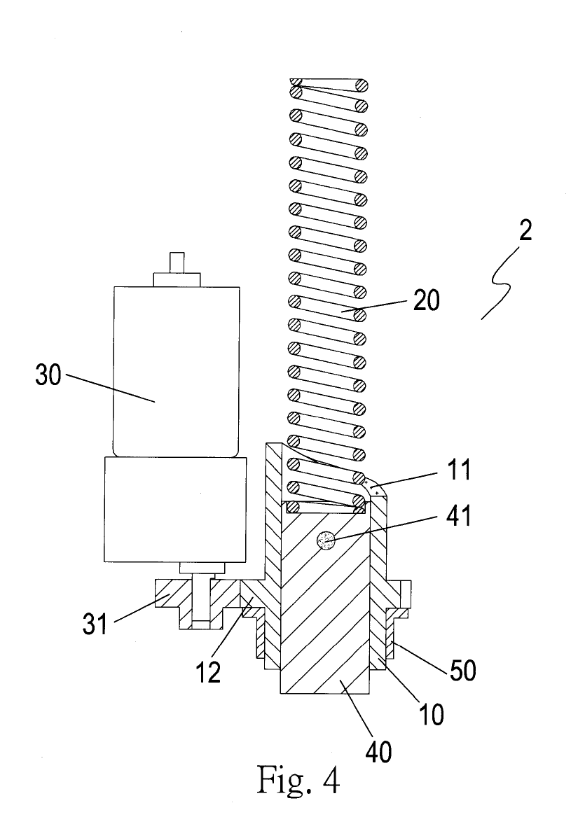

Referring to FIGS. 3 and 4, it is illustrated that an actuator 30 is formed aside the driving unit 2. The actuator 30 is one of a motor, a liquid pressure motor, a pneumatic motor, an engine, or is driven manually. An outer shaft of the actuator 30 is installed with a transfer gear 31. The transfer gear 31 is engaged to the driven gear 12 of the driving rotary cylinder 10. As the transfer gear 31 rotates, the driven gear 12 will be driven to rotate along the driving bush 50. At the same moment, the driving pin 41 will be driven so as to further drive the impact unit 40 to compress the spring 20 to store potential energy.

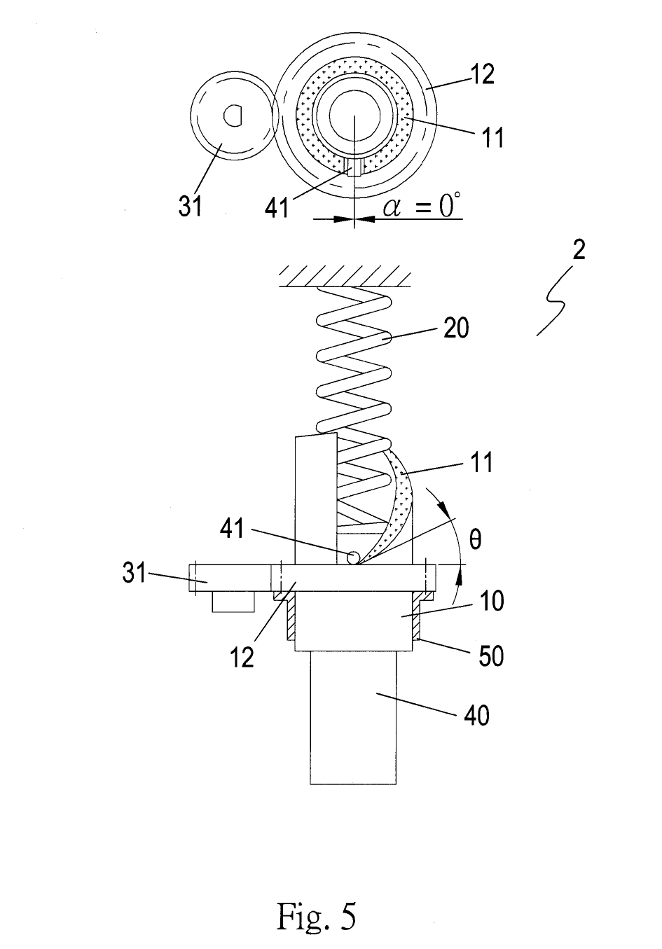

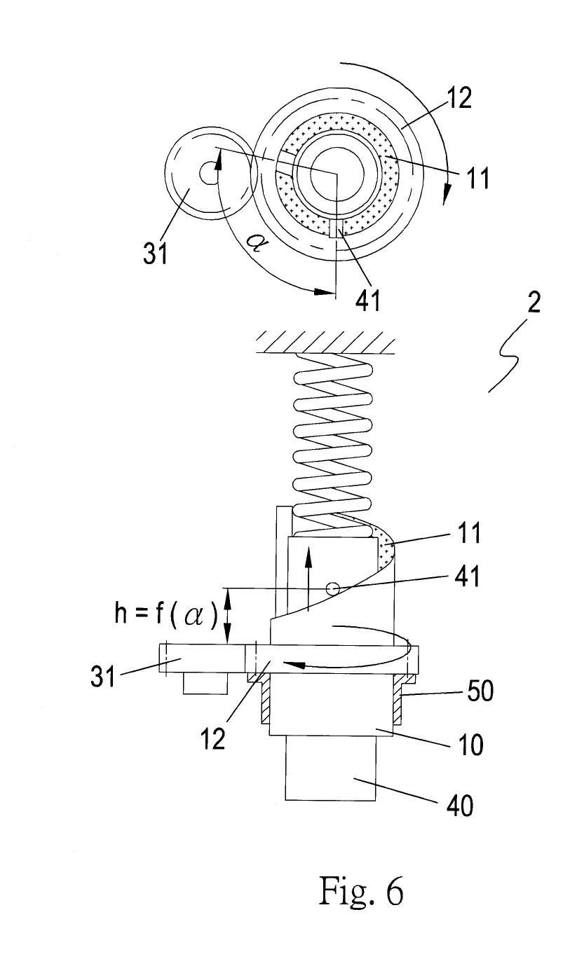

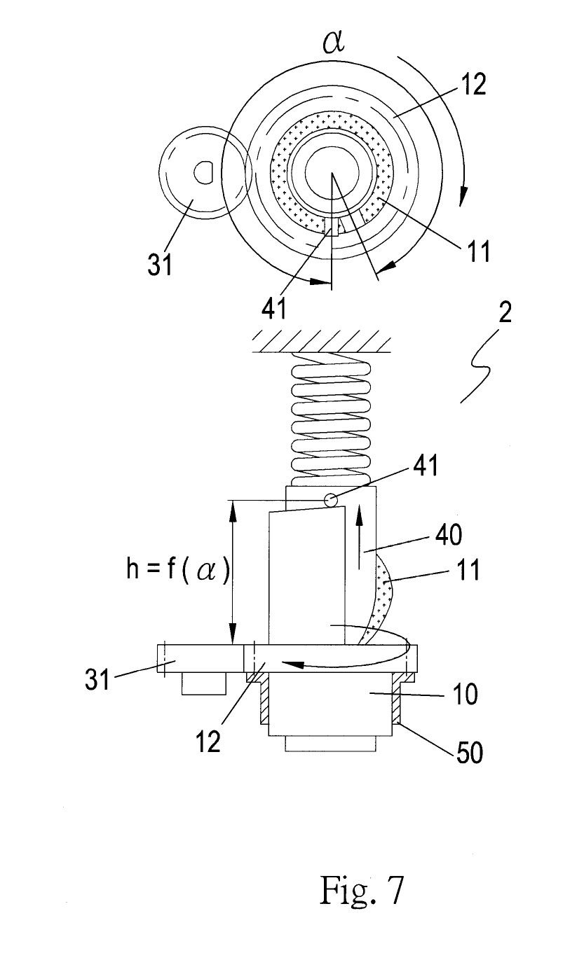

Referring to FIGS. 3, 5, 6 and 7, it is illustrated when the rotation angle α of the driving rotary cylinder 10 is 0 degree, the height of the driving pin 41 is reset. When the height of the driven gear 12 is increased, the rotation angle is also increased and thus the driving pin 41 moves higher and higher. When the rotation angle α is 360 degrees, the driving pin 41 moves to the top, that is to say, when the rotation angle α is over 360 degrees, the height is reset.

When the driving unit 2 moves, the impact unit 40 will move higher with the driving surface 11 of the driving unit 2 and the spring 20 compresses for storing energy. When the impact unit 40 is lifted to a predetermined height, the rotation angle α of the driven gear 12 increases to be over 360 degrees, it will reset so that the spring 20 will release potential energy to be converted into dynamic energy. When the impact unit 40 is driven, the structure generates a beating due to power.

To further, the present invention is installed with a driving rotary cylinder 10 which is driven by the actuator 30. The driving rotary cylinder 10 is installed with an axial driving surface 11. The rotation of the driving rotary cylinder 10 will drive the impact unit 40 to move upwards and downwards. The height of the driving surface 11 is increased linearly. The height h=f(α), where α is between 0 to 360 degrees. f( ) is a function.

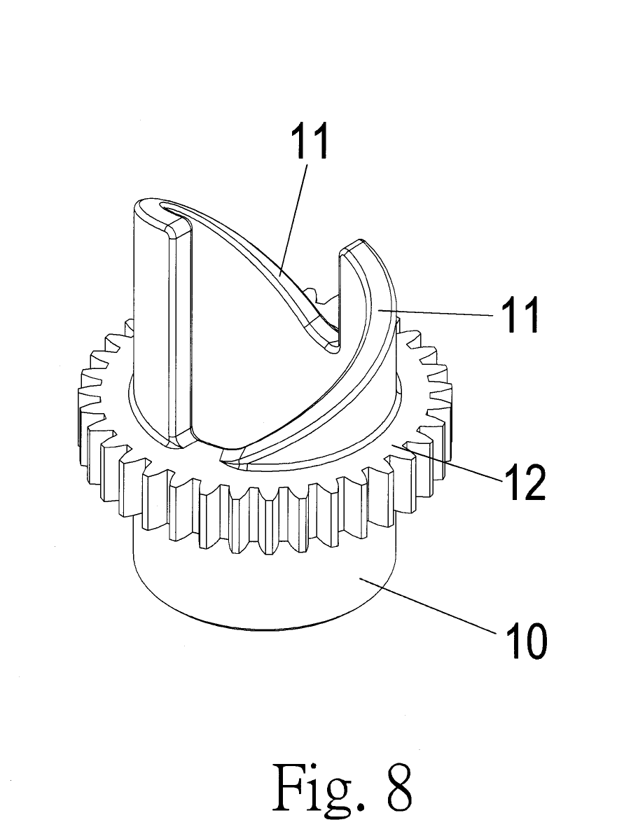

Referring to FIG. 8, the application of the present invention will be described herein. The driving rotary cylinder 10 has a plurality of driving surfaces 11. The axial driving surface 11 of the driving rotary cylinder 10 has a height which is increased in rotation direction, where h=Aα+B, when the α is between 0 and 360 degrees, in that A and B are constant value, in the formula, B is zero and A=tan(α)*H, in that H is a maximum spring displacement value, as α=0, h=0.

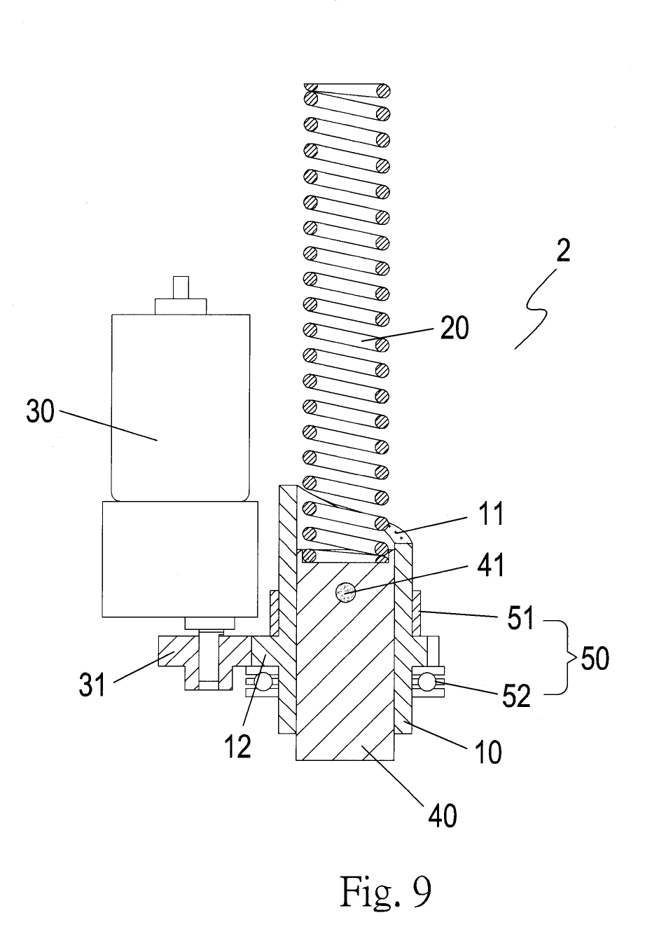

With reference to FIG. 9, it is illustrated that the driving bush 50 contains a liner 51 enclosing the driving rotary cylinder 10 at an upper side of the driven gear 12 and a bearing 52 below the driving rotary cylinder 10.

Advantages of the present invention will be described herein. In the driving unit, the spring unit is used for storing and releasing energy for driving an impact unit so that the electric power efficiency is higher and the weight is light. It is especially advantageously to be used in handset. The driving unit of the present invention uses a spring to store energy which is suitable for outputting power with a battery so as to reduce the current of the battery and has a higher output efficiency.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A power beating device using the inclined plane principle comprising: a driving unit having an spring for storing and releasing energy so as to drive an impact unit; wherein the driving unit has at least one driving surface; an actuator serving to actuate the driving surface so that the impact unit is lifted with the driving unit, and the spring deform to store energy; when the impact unit is lifted to a predetermined height, it will rest and then the spring will release energy to drive the impact unit to have the effect of beating.

2. The power beating device as claimed in claim 1, further comprising a driving rotary cylinder which is driven by the actuator the driving rotary cylinder being installed with an axial driving surface; the driving rotary cylinder being rotatable so as to move longitudinally; a height of the driving surface being increased along a rotation direction; wherein the height h=f(α), where α is between 0 to 360 degrees; f( ) is a function.

3. The power beating device as claimed in claim 2, wherein the driving rotary cylinder is installed with a driving bush or a bearing.

4. The power beating device as claimed in claim 3, wherein the driving bush or a bearing further includes a radial bush and an axial bearing.

5. The power beating device as claimed in claim 2, wherein the driving rotary cylinder is a round cylinder.

6. The power beating device as claimed in claim 2, wherein the driving surface is a helical surface and the helical angle θ is varied with a height of the helical surface.

7. The power beating device as claimed in claim 1, wherein the driving unit has a plurality of driving surfaces; a height of each driving surface is increased along a rotation direction; driving surface of the driving rotary cylinder has a height “h” which is increased in rotation direction, in that, h=Aα+B, where the α is between 0 and 360 degrees, in that A and B are constant.

8. The power beating device as claimed in claim 1, wherein the actuator is one of a motor, a liquid pressure cylinder, a pneumatic cylinder, a liquid pressure motor, a pneumatic motor, an engine and manual power.

9. The power beating device as claimed in claim 1, wherein there is one or a plurality of impact units.

10. The power beating device as claimed in claim 1, wherein the driving unit is a wedge driving block which is driven by an actuator, the driving surface of the driving block has an inclined plane and the driving unit has at least one driving surface; there is at least one impact unit; a height of the impact unit is increased with the displacement of the impact unit; the displacement of the impact unit is a serration so as to cause the spring has a maximum displacement and then the height is reset.
